(19) United States
(12) Patent Application Publication
(10) Pub. No.: US 2009/0175490 A1
(43) Pub. Date: Jul. 9, 2009

(54) Watermark display controller and method

(76) Inventor: William Pat Price, Rhome, TX (US)

Correspondence Address: HENNEMAN & ASSOCIATES, PLC, 714 W. MICHIGAN AVE., THREE RIVERS, MI, 49093, US

(21) Appl. No.: 12/008,234

(22) Filed: Jan. 9, 2008

(51) Int. Cl. G06T 1/00

(52) U.S. Cl. 382/100

(57) ABSTRACT

A method and device for displaying a watermark on a display 15 of material has been deleted by fast forwarding or reversing during recording of audio/video content. The device includes a watermark controller 12 which detects when material sought to be watermarked is present and provides a watermark to display 15 when such material has been deleted by fast forwarding or reversing during recording. Methods for accomplishing this procedure are shown, including the controller, in television receivers 14 and video recorders 20. A method 30 for detecting the presence of material such as advertisements and skipping is shown which adds a flag to indicate when such an event has occurred. The flag induces the inclusion of a watermark on the display or recording produced.

### BACKGROUND OF THE INVENTION

1. Field of Invention

This invention relates generally to digital video and audio reproduction systems such as those used for home entertainment, and particularly to an apparatus and method to display the watermark or logo of a company on a television screen during use of a commercial-skip feature.

2. Background Art

Through application of digital television technology, a time-shifting feature has been provided for consumer AV systems that allows a broadcast program to be viewed at a more convenient time. Digital televisions (TVs) and video recorders (DVRs), also called personal video recorders (PVRs), such as those pioneered by TiVo, Inc., can receive digital video broadcasts in the ATSC (Advanced Television Standards Committee) format, and can also receive and digitize analog video broadcast signals, and can store (record) program content in digital form to a hard disk drive (HDD). Viewers can subscribe to services that provide electronic programming guides on the TV display screen, and can record programs that will be broadcast at some time in the future. Another set of features allows viewers to store a program while viewing it, then pause to a freeze frame while continuing to store, and resume viewing (this time) from the stored content, at the freeze frame address. While these time shifting features are attractive to the user, they have endangered the traditional business model of the broadcast industry by giving viewers the ability to “skip” or jump over and “fast forward” through segments of a program. Viewers typically use these features to skip over and fast forward through advertisements and promotional messages (also called ads or commercials), thereby reducing their exposure to the ads. Such exposure, however, is a necessary component of the business model, as it delivers a statistically significant increase of demand for the advertised products and services as a function of the amount of viewer exposure, and this pays for the program content and broadcasting costs. One proposed remedy is to adapt the hardware of HDDs, DVRs, and TVs to prevent skipping of ads, and some consumer electronics manufacturers have provided for a “fast forward” to be executed in place of a “skip” or jump-ahead command during a portion of skipped content that is an advertisement. Another proposed remedy is to display an alternate, banner type of advertisement on the TV screen or monitor during skipping or fast forwarding though an ad. Such remedies are not completely satisfactory, however, and a need exists for a better way to compensate for the loss of viewer exposure to ads resulting from time-shifting technology.

### SUMMARY OF INVENTION

A method and device for displaying a watermark on a display if material has been deleted by fast forwarding or reversing during recording of audio/video content. The device includes a watermark controller which detects when material sought to be watermarked is present and provides a watermark to the display when such material has be deleted by fast forwarding or reversing during recording.

A method for accomplishing this procedure is disclosed which monitors the material being recorded and the recorder to determine if the material, such as an advertisement, has been deleted. When the material has been deleted a watermark is sent to the reordering to indicate the deletion. The method includes various locations of watermarks and differing methods of producing such watermarks and connecting to different components such as television receivers and video recorders.

The controller may optionally be located in either television receivers or video recorders.

### BRIEF DESCRIPTION OF THE FIGURES

In the accompanying drawings:

FIG. 1 is a block diagram of a watermark display controller, according to the invention, connected to an audiovisual system enabled for time-shifting;

FIG. 2 is a flow diagram of the method of the invention to compensate for ad-skipping;

FIG. 3 is a symbolic view of a TV display showing a plurality of watermark locations, according to the invention.

### DETAILED DESCRIPTION OF THE FIGURES

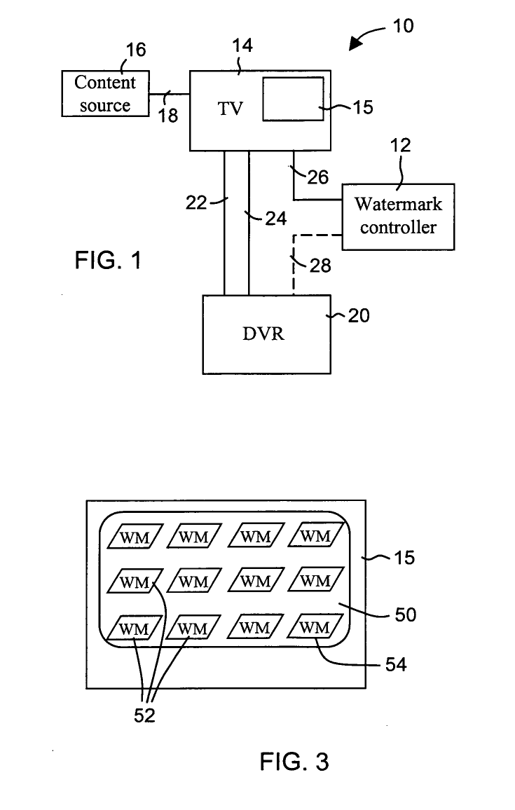

FIG. 1 shows, in block diagram form, an example of an audiovisual (AV) system 10 enabled for time shifting and including a watermark display controller 12. Watermark display controller 12 displays a watermark to compensate for commercial-skipping, according to this embodiment of the invention. The system further includes a digital television (TV) device 14 with display (monitor) subsystem 15, which is adapted to receive incoming broadcast video content, and alternatively incoming (downstream) IP protocol content from the internet, from content source 16 over input connection 18. Content sources 16 and input connections 18 may include cable systems, terrestrial broadcasts, satellite systems, digital packet streams delivered over DSL or Cable modems, and wireless networks such as 802.11b and g. In addition, content may be received through a personal computer (PC) system. Input connection 18 can also be implemented by laser transmission links through fiber optic cable, through free air, and by time domain transmission. The system 10 still further includes a digital content storage device DVR 20 connected to TV 14 by interconnecting links 22 and 24.

Links 22 and 24 may also include the IEEE 1394 (herein referred to as “1394”) serial bus known in the art, which has been adopted as the High Definition Audio-Video Network Alliance (HANA) standard connection interface for AV device communication and control, can be used for the interconnecting links. Other known interconnection means for links 22 and 24 include Ethernet, Universal Serial Bus (USB), and 155 Mb/s ATM. Alternate embodiments of the invention allow link 22 to interconnect and interoperate primarily with the receiver and demodulator subsystem of TV 14, to store incoming content on DVR 20, and the link 24 can interconnect and interoperate mainly with its display subsystem 15, to view (reproduce, play back) the stored content. Although interconnecting links 22, 24 are shown in FIG. 1 as separate for purposes of functional description, they can be implemented in one physical 1394 bus link with associated firmware implementation.

TV 14 and DVR 20 may have digital rights management (DRM) capability, for example, including authentication, key exchange, decryption, and encryption capabilities according to the Digital Transmission Content Protection (DTCP) standard. In alternate embodiments, TV 14 may receive incoming analog content and digitize said content prior to being stored on DVR 20. It should be understood that incoming content to TV 14 may alternatively be viewed on TV 14 as it is received, without necessarily being stored on DVR 20.

In this embodiment shown, watermark display controller 12 is operationally connected to TV 14 by interconnection 26. An alternate embodiment has watermark display controller 12 operationally connected to DVR 20, via interconnection 28. In a still different embodiment of the invention, a 1394 bus can be employed for interconnection 26. Although watermark display controller 12 is shown in FIG. 1 as a separate block, it can further alternatively be implemented in form of a digital subsystem of TV 14 and physically disposed therein. In yet another alternative embodiment, watermark display controller 12 is embodied in firmware as a virtual functional subsystem, for example, within the display or monitor subsystem of TV 14. In these alternate embodiments, interconnection 26 can symbolically represent a plurality of functional circuit and software interactions appropriate to the operation of the watermark display controller 12 inside TV 14. Yet further alternatively, the watermark display controller 12 can be implemented in form of a digital or virtual functional firmware subsystem of DVR 20.

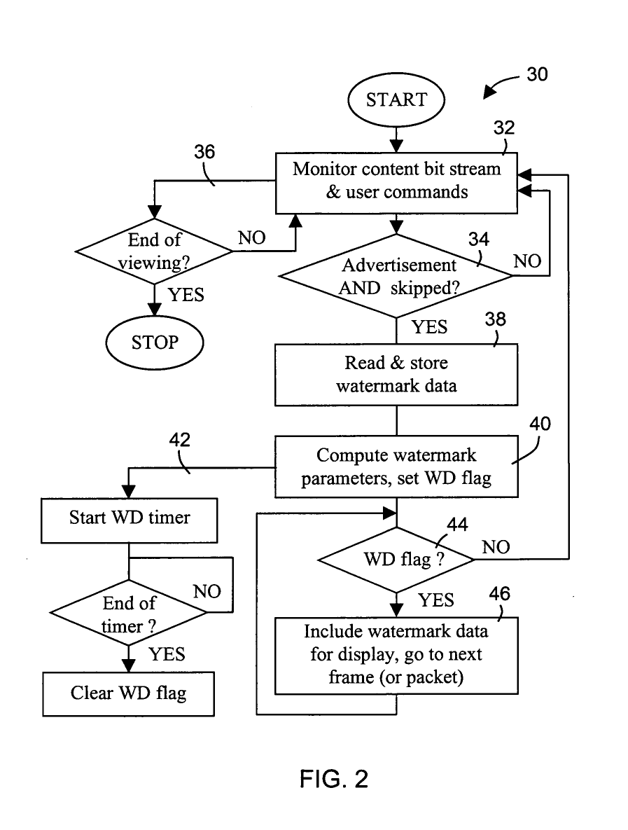

FIG. 2 is a flow diagram of a first embodiment of the method. The operation capabilities of watermark display controller 12, according to the method of the invention, are shown in the examples below. In a typical example of operation, an AV content object such as a movie M is received by TV 14, in the form of an MPEG-2 bit stream. The bit stream is recorded automatically on DVR 20 prior to viewing. The stored copy of the content will then exist that can be viewed later. An MPEG-2 content bit stream (sometimes called a transport stream) comprises packets of known size, with each packet containing content identification (ID) and content protection information. The content ID field can include some amount of custom (private) information, which will herein be referred to as watermark data, for example the name, logo, a graphic image, or a short text message associated with an advertiser or content owner who is supporting the broadcast or otherwise supplying the content. For example, if an automotive company is presenting a TV advertisement for a new car or truck, the watermark data might comprise a graphic image of the model, its name, the manufacturer's name or logo, or a text slogan. The watermark data may further include a sound component. An MPEG-2 bit stream can yet further contain AV content for several programs (sometimes called AV objects) simultaneously; as all packets of a particular AV object contain the same identification, a digital device such as the watermark display controller 12, can segregate, view, and store, only the packets for that object.

Viewing of the stored AV object (movie M) starts by a suitable user command applied to TV 14, or alternatively to DVR 20. The command is entered in this example by using the front panel controls or a remote control. The result is an (decrypted, if applicable) AV bit stream of M transmitted to the display subsystem 15 of TV 14, for viewing.

The sequence of steps 30 of the operation of the watermark display controller 12, according to a first embodiment of the method of the invention, is depicted in FIG. 2. In the first step 32 of the operation, the content bit stream of M and user commands are monitored. The content bit stream is monitored in order to detect whether the current content packet is (part of) a qualified advertisement or promotional message for which viewer exposure is desired. This is accomplished in this embodiment by reading an appropriate field in the ID information of a packet. Such qualification can be included by the advertiser or content owner in suitable ID information bits, which can be part of watermark data. Other methods are within the inventions method, such as coded signals within the content or supplementary data in meta information or the like. User commands are simultaneously monitored in order to detect whether a command to skip (jump) ahead or to fast forward is in effect, which will be used in step 34. In addition, user commands are monitored to determine whether a command to end the current viewing session has been entered, which will be used in operation branch 36. These commands, together with the presence or absence of a content stream transmitted for viewing, are used to determine the end of viewing and accordingly to stop the current operation sequence of the watermark display controller 12. In the second step 34, the operation branches back to step 32 for monitoring of the next frame (alternatively, the next packet), if the current frame (or packet) is not (part of) a qualified advertisement, and also if it is an advertisement being viewed without skipping or fast-forwarding. If skipping or fast-forwarding through a qualified advertisement is detected in step 34, operation branches to step 38, wherein watermark data is read from the custom (private) information field of the current packet, and temporarily stored in memory, for example in RAM, and skipping events can be logged and temporarily stored. In the next step 40, watermark display parameters can be computed, for example, the time duration of display, the location on the display screen, and choice or alternation between watermarks if more than one is provided, and the watermark display (WD) flag is set. It is envisioned according to the invention, that a plurality of watermark display protocols can be provided in the custom information field, at the option of the advertiser or content owner, and further that such protocols can be predetermined and appropriately coded (for brevity in the custom information field) cooperatively within the industry. Watermarks can be displayed, for example, according to predetermined standard choices, further alternatively, with the help of standard applets provided in a watermark display controller 12, or in a suitable ROM elsewhere within a TV or DVR.

Logical operations can be performed in step 40 for conditional watermark display, for example, to display a watermark only after a given number of ad skipping events, within a given viewing time period, i.e., according to a skipping pattern apparent from a user command log stored temporarily in step 38, and according to instructions that can be provided in the custom information field of packet ID information and read in step 38, so that the WD flag will not be set under some conditions. Another type of logical operation in step 40 can be to determine and set the levels of visual and sound qualities of a watermark, according to information from step 38. Such logical operation of controlling a watermark can be designed to reduce advertisement skipping by a user, for example, by providing a less obtrusive watermark in case of infrequent skipping.

When a WD flag is set in step 40, a watermark display timer is started in a parallel branch of operation 42, wherein the WD flag is cleared after a time period determined in step 40. In step 44 of operation, following step 40, the WD flag is checked (so that the same watermark parameters can be used without need of repeating the steps 32 through 40 during a watermark display period). If the WD flag is not set, operation loops back to step 32 and continues in the same manner as described hereinabove, until it stops as determined in branch 36. If the WD flag is set, operation continues from step 44 to step 46, wherein the watermark data is added to the content bit stream of M being transmitted to the display subsystem 15 for TV 14, for viewing, until the WD flag becomes cleared in branch 42 or operation stops in branch 36.

For implementing the displaying of watermark data (in step 46 of operation), the digital TV 14 can be provided with the capability to overlay another image on top of an AV object being viewed, according to the graphic planes method of compositing a multiplicity of graphics planes with transparency into a single on-screen display, as known in the art. Such a method is commonly used for “closed captioning”, for scrolling banner presentation of other news headlines, financial news items and the like, during a main news program, and for transparent overlay of an electronic program guide provided by some content distribution and broadcasting services, during certain user command operations.

FIG. 3 illustrates an example of a screen 50 of a digital TV display subsystem 15, showing a multiplicity of possible locations 52 wherein a watermark 54 can be displayed, as noted hereinabove in the description of step 40. An alternate known technique to implement the displaying of watermark data (in step 46 of operation) on screen 50 allows a watermark display controller 12 to send graphic bit maps comprising the watermark data, over a 1394 bus interconnection 26 to TV 14, to be displayed as overlaid images. Yet another technique, by which display of watermark data in step 46 can alternatively be implemented, allows a digital TV to receive and display watermark data contained in an HTML page, by providing a web browser in its firmware.

It is expected that there will be a great many applications for these which have not yet been envisioned. Indeed, it is one of the advantages of the present invention that the inventive method and apparatus may be adapted to a great variety of uses.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

It is anticipated that the access point will have wide use in a multiplicity of consumer and professional electronic systems, including, for example, set top boxes, media server computers, HDD and DVD recorders, displays (monitors) of Personal Computers, TV sets, home music systems, portable music recorders and players, and personal communication devices.

### INDUSTRIAL APPLICABILITY

The inventive apparatus and method are intended to be widely used in a great variety of electronic applications. It is expected that they will be particularly useful in consumer electronic applications where significant storage capacity and speed is required.

It is anticipated that the content-protection access controller will have wide use in a multiplicity of consumer and professional electronic systems, including for example, set top boxes, media server computers, HDD and DVD recorders, displays (monitors) of Personal Computers, TV sets, home music systems, portable music recorders and players, and personal communication devices.

Since the inventive storage system and method of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

1. A method for displaying a watermark during playback of audio/visual material comprising the steps of: monitoring the content of said audio/visual material for the presence of data indicating an event for which watermark display is desired, and further monitoring of user commands to determine if accelerated playback is being performed, reading and storing watermark data if both an event for which watermark display is desired and accelerated playback is being performed, and displaying said stored watermark data during playback.

2. A method for displaying a watermark during playback of audio/visual material as in claim 1, comprising the further step of computing watermark parameters of said stored and read watermark data before display of said watermark data.

3. A method for displaying a watermark during playback of audio/visual material as in claim 2, wherein said computing step includes the step of setting a flag and displaying said watermark data upon playback when a such flag is present.

4. A method for displaying a watermark during playback of audio/visual material as in claim 3, comprising the further steps of starting a timer for an interval and clearing said flag when such interval has elapsed. A method for displaying a watermark during playback of audio/visual material

5. A method for displaying a watermark during playback of audio/visual material as in claim 1, comprising the further steps of determining whether viewing has ended and stopping the process if the viewing has ended.

6. A method for displaying a watermark during playback of audio/visual material as in claim 1, wherein said audio visual material is a bit stream of digital data.

7. A method for displaying a watermark during playback of audio/visual material as in claim 6, wherein said digital bit stream is further comprised of packets of data having associated headers containing information indicating the presence of an advertisement.

8. A system for displaying a watermark upon playback of audio/visual material comprising a display for displaying audio/visual material, and a recording device including a fast forward/reverse function connected to said display for recording audio/visual material, and a source of audio/visual content including an indication of when such content should be watermarked on playback connected to said recorder, and a watermark controller connected to said recorder for providing a watermark when said forward/reverse function is activated during said indication.

9. A system for displaying a watermark upon playback of audio/visual material as in claim 8, wherein said recording device is a digital video recorder.

10. A system for displaying a watermark upon playback of audio/visual material as in claim 8, wherein said display is a portion of a television receiver connected to said recorder and said source.

11. A system for displaying a watermark upon playback of audio/visual material as in claim 10, wherein said watermark controller is located in said television receiver.

12. A system for displaying a watermark upon playback of audio/visual material as in claim 10, wherein said watermark controller is located in said recorder.

13. A system for displaying a watermark upon playback of audio/visual material as in claim 10, wherein said watermark controller is connected to other components by 1394 bus connections.

14. A system for displaying a watermark upon playback of audio/visual material as in claim 8, wherein said audio/visual material is a series of packets, each packet having a header that provides information whenever an advertisement is present and said watermark controller provides a flag to said recorder when an advertisement is being skipped.

15. A watermark controller for use in audio/video systems for displaying a watermark upon playback of audio/video material at the point where selected material was deleted comprising: a detector for detection when material selected to be watermarked is present; a link for connecting said detector to a source of audio visual material; and a second link for connecting to a recorder to determine if said recorder is in a fast forward/reverse mode; and a controller which provides a signal if material sought to be watermarked is present and said recorder is in fast forward/reverse mode; and a third link from said controller for displaying a watermark when said signal is present upon playback.

16. A watermark controller for use in audio/visual systems for displaying a watermark upon playback of audio/visual material as in claim 15, wherein said material is a stream of packets, each packet having a header which indicates if an advertisement is present and said detector detects such a header.

17. A watermark controller for use in audio/visual systems for displaying a watermark upon playback of audio/visual material as in claim 15, wherein said watermark controller is physically located in a television receiver.

18. A watermark controller for use in audio/visual systems for displaying a watermark upon playback of audio/visual material as in claim 15, wherein said watermark controller is physically located in a digital video recorder.

19. A watermark controller for use in audio/visual systems for displaying a watermark upon playback of audio/visual material as in claim 15, wherein said third link is connected directly to a display for displaying a watermark on said display.

20. A watermark controller for use in audio/visual systems for displaying a watermark upon playback of audio/visual material as in claim 15, wherein said third link is connected directly to a digital video recorder for displaying a watermark on any recording produced by said recorder when said recorder has been used to delete an advertisement.
